(19) United States
(12) Patent Application Publication
(10) Pub. No.: US 2006/0180505 A1
(43) Pub. Date: Aug. 17, 2006

(54) Separation method and apparatus incorporating materials having a negative poisson ratio

(75) Inventors: Andrew Alderson, Preston (GB); Kenneth Ernest Evans, Exeter (GB); John Rasburn, Exeter (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: British Nuclear Fuels Plc

(21) Appl. No.: 11/385,407

(22) Filed: Mar. 21, 2006

Related U.S. Application Data
(63) Continuation of application No. 10/944,633, filed on Sep. 17, 2004, now abandoned.
Application No. 10/944,633 is a continuation of application No. 10/237,005, filed on Sep. 5, 2002, now abandoned.
Application No. 10/237,005 is a continuation of application No. 09/530,765, filed on Jul. 24, 2000, now abandoned.

(30) Foreign Application Priority Data
Nov. 4, 1997 (GB) 9723140.1
Nov. 4, 1998 (WO) PCT/GB98/03281

(51) Int. Cl. B32B 3/10; B01D 27/00

(52) U.S. Cl. 209/235; 428/131; 210/436

(57) ABSTRACT

A method of separating at least part of one or more components from a mixture of components includes exposing the mixture to a porous barrier, the barrier being formed of a material structure having, or behaving in the manner associated with, a negative Poisson ratio. Through the use of such materials, improved reparations, improved de-fouling of barriers and a variety of other beneficial properties can be obtained.

### CROSS-REFERENCE TO RELATED APPLICATIONS

This application is a continuation application of U.S. patent application Ser. No. 10/944,633, filed Sep. 17, 2004, which is a continuation of U.S. patent application Ser. No. 10/237,005, filed Sep. 5, 2002, which is a continuation of U.S. patent application Ser. No. 09/530,765, filed Jul. 24, 2000, abandoned, which is a U.S. nationalization of International Application No. PCT/GB98/03281, filed Nov. 4, 1998, which claims priority to Great Britain Patent Application No. 9723140.1, filed Nov. 4, 1997, which applications are herein incorporated by reference in their entireties.

### BACKGROUND OF THE INVENTION

1. Field of the Invention

This invention concerns improvements in and relating to material separations, particularly, but not exclusively, to separations based on material size or material shape or material phase.

2. Present State of the Art

A wide variety of industrial processes involve the separation of materials from one another based on the passage of one or more components through, or across, a barrier and the retention of other components of the system by the barrier. Such processes include solid/liquid separations (filtration), gas/gas separations (molecular sieves), solid/gas separations (air filtration) and many more.

An inevitable part of any process which resists the passage of components through a barrier is that some of the components will enter and become lodged in the barrier. These components may lead to barrier fouling and reduce the efficiency of the process. To maintain stable operating conditions in such circumstances may require complex adjustment of the operating conditions. In any event it is often necessary to employ techniques for removing such materials which are time consuming and problematical; the movement of the component backwards is also resisted by the barrier.

### BRIEF SUMMARY OF THE INVENTION

The present invention aims to provide new barrier materials or structures, modes of operating them and methods of construction, with a view to addressing the above identified and other problems.

According to a first aspect of the invention we provide a method of separating, at least part of one or more components, from a mixture of components, the method comprising exposing the mixture to a porous barrier, the barrier being formed of a material or structure having, or behaving in the manner associated with, a negative Poisson ratio.

Such behavior may be taken to comprise deformation of the same kind and nature occurring laterally in one or more directions to the applied direction. Poissons ratio is generally taken to be defined in terms of the strain which occur when a material is stretched or compressed and is equal to minus the transverse strain divided by the axial strain in the direction of stretch or compression.

$$υ xy = \frac{ⅆ ɛ y}{ⅆ ɛ x}$$

The method may include the generation of, or variation of, a tensile or compressive load or displacement in one or more directions in the barrier material. The method may include the provision of a first level of a tensile or compressive load or displacement in one or more directions of the barrier material and a second level of tensile or compressive load or displacement in one or more directions in the barrier material, the first and second levels being provided at different times. The load may be generated substantially perpendicular and/or substantially parallel to a direction of flow of one or more components through the barrier.

The load or displacement may be generated by applying a tensile force to one or more parts of the barrier. The load or displacement may be generated by applying a compressive force to one or more parts of the barrier. The parts may be one or more edges and/or sides of the barrier. A tensile and/or compressive load or displacement may be applied in two directions. The directions may both be in the plane of the barrier material, for instance at 90° to one another. The directions may both be perpendicular to the flow of one or more components through the barrier.

The load or displacement may be generated by variation in the pressure differential across the barrier. The pressure differential may arise through variation of the pressure on one or both sides of the barrier. The pressure differential may be controlled externally.

The load or displacement may be generated by variation in the pressure across the barrier due to the variation in the effective porosity of the barrier. The effective porosity may vary due to the extent of pores blocked or restricted by components in the pores. The load or displacement may be generated by variation in the flow rate on one side of the barrier relative to the flow rate on the other side of the barrier.

The load may result in deformation of the barrier. The deformation may comprise stretching and/or compression of one or more portions or all of the barrier. The deformation may comprise bowing of the barrier, particularly of its centre. The bowing may occur towards the lower pressure side of the barrier.

The load or displacement preferably varies the effective pore size of the barrier. The effective pore size may be varied to counteract the reduction in effective pore size due to fouling of the barrier by one or more components. The compensation may arise automatically due to pressure variation and/or may be controlled externally.

The barrier may be provided with effective pore sizes of between 1 Å and 1 m, more preferably between 1 micron and 5 cm. Thus such barrier materials are applicable to applications calling for pore sizes necessary to interfere with the passage of gas molecules right up to pore sizes intended to screen large solid particles relative to other solid particles. Preferably through pores are provided between at least one surface of the barrier and at least one other surface.

The effective pore size may be increased by up to 1%, up to 3%, up to 10%, or preferably up to 20% and even greater than 50% by the application of stress to the barrier material.

The effective Poisson ratio for the barrier may be provided down to −0.1, −0.2, −0.3, −2, or even down to −20. The larger the magnitude of the Poisson ratio the better, as less applied strain is consequently required to give the desired change in effective pore size.

The barrier material or structure may be auxetic. The material or structure may be provided with a tessellated re-entrant pattern, most preferably of honeycomb form. The barrier material or structure may be provided as a 2-dimensional barrier (a single layer) or comprise a 3-dimensional barrier. The 3-dimensional barrier may be provided by two or more layers. The pores in respective layers may be aligned or offset relative to one another.

The mixture of components may include solid and/or liquid and/or gaseous components. The mixture may include one or more components in such states. The mixture may be a solid/gas and/or solid/liquid and/or solid/solid and/or liquid/gas and/or liquid/liquid and/or gas/gas mixture. Solids, liquids and gases may be present.

The mixture may be of different particle sizes, for instance a mixture of solid particles to be screened and/or a mixture of different sorbates to be separated. The mixture may be of different molecule sizes, gaseous and/or liquid, for instance a feed to a selective gas separation or selective ion exchange. The mixture may be of dissolved species and solvent, for instance a feed to a reverse osmosis process.

The mixture of the components may be exposed to the barrier in a first volume. The mixture of components may be introduced to the first volume via an inlet. The first volume may be separated from a second volume by the barrier.

At least part of at least some of the mixture of components may exit by an outlet provided in the first volume. Alternatively or additionally at least part of at least some of the mixture of components may exit by an outlet provided in the second volume.

The method of separating may comprise the passage of one or more components through the barrier. The said one or more components may substantially all pass through the barrier. For instance, where the said one or more components are to exit through the second volume only. Alternatively a portion of the said components may pass through the barrier with the remainder staying in the first volume. For instance, where the said one or more components are to exit through the first and second volume.

The method may comprise the retention of at least part of at least one component of the mixture by the barrier. The at least one component may be retained on the surface of the barrier and/or in the barrier and/or be retained in the first volume side by the barrier. Thus the at least one component may build up on the surface of the barrier and/or the at least one component may build up in the pores of the barrier and/or the at least one component may remain in the first volume.

The passing component may be a gas, with solids retained. The passing component may be a liquid, with solids retained. The passing component may be solid, with solids of a larger size being retained. The passing component may be a gas with a different gas being retained, most preferably the larger gas molecules are retained. The passing component may be a liquid with dissolved ions being retained. The passing component may be a liquid and one or more dissolved ions or vice versa with one or more different ions being retained.

The barrier material or structure may be polymeric. The barrier material or structure may be made of, for instance, a polyurethane-co-ester. The barrier material or structure may be formed from an open pore foam.

The barrier material or structure may be formed from silicon.

The barrier material or structure may be formed of molecular level material, such as zeolites, including ZSM5 and others.

The method may include a first stage during which the pore size of the barrier is not varied. This stage or alternatively a stage of the type outlined above in which variation of the pore size occurs may be followed by a stage for removing one or more components retained on or in the barrier, the further stage comprising the generation of or variation of a tensile and/or compressive load or displacement in one or more directions in the barrier, the load and/or displacement causing a variation in the effective pore size of the barrier in one or more directions.

In this way, the retained components can be encouraged to separate from the barrier surface and/or exit the barrier.

Preferably a flow of material, most preferably a liquid or gas, is applied to the barrier during this stage or a portion thereof. In this way removal of the components is promoted. A backwashing stage may be provided. A cross-flow flushing stage may be provided. Preferably the flow of material is provided perpendicular to the flow of material through or into the barrier during the first stage and/or at 180° to the flow of material through the barrier or into the barrier during the first stage.

The effective pore size of the barrier may be varied by any one or more of the ways of varying the pore size set out above.

The effective pore size may be varied by bowing the barrier in an opposing direction to the flow of material into or through the barrier during the first stage.

The load or displacement applied to the barrier during the second stage may be applied in a varying manner, for instance cyclicly, to promote de-fouling.

The barrier material or structure may be anisotropic.

In a particularly preferred method a flow containing a mixture of components may be introduced through a conduit to one side of a barrier, at least part of one or more components of the mixture passing through the barrier and flowing through a second conduit, on the opposing side of the barrier, away from the barrier, the method further comprising, at least some of the time, in applying a flow of material across the barrier relative to the first flow. Preferably the cross flow is accompanied by a variation in the effective pore diameter of the barrier material, most preferably perpendicular to that flow direction only. In this way cross flow cleaning of the barrier can be provided. The cross flow cleaning may be provided alongside flow from the first to second conduit or at a different time.

According to a second aspect of the invention we provide separation apparatus, the apparatus comprising an inlet for receiving a mixture of components, a porous barrier to which the mixture of components are exposed and an outlet for the mixture after exposure, the porous barrier having pores adapted to restrain the passage of one or more components of the mixture, the porous barrier being formed of a material or structure exhibiting the behavior exemplified by a negative Poisson ratio.

The apparatus may include means for applying or varying a tensile or compressive load in one or more directions in the barrier material. The means may apply or vary the loads substantially perpendicular to and/or substantially parallel to a direction of flow of one or more components through the barrier. There may be instances where uniaxial variation gives rise to auxetic properties, but biaxial variation does not give pore variation. However, where biaxial effects do function, biaxial application/variation is preferred, preferably through axis 90° to one another, most preferably in the plane of the barrier.

The load applying means may comprise one or more elements opposing one another, the separation of which is increased to generate the tensile load. The load applying means may comprise one or more elements the separation between which is reduced to generate a compressive load on the barrier. The load means at 90° to one another may be provided to generate loads in two directions.

The apparatus may include means for varying pressure on one side of the barrier compared with the pressure on an opposing side of the barrier.

The separation apparatus may comprise an anisotropic barrier material or structure, the apparatus being provided with load generating means adapted to compress or stretch the auxetic material or structure parallel to a direction of flow of one or more components, of a mixture including one or more other components, through the barrier, the apparatus further comprising means for applying a flow of material through the barrier in a different direction to the first. Preferably the different direction is at 90□ to the first. A backwashing feature for the auxetic barrier material or structure may be provided in this way.

According to a third aspect of the invention we provide a method of removing one or more retained components from a porous barrier, the porous barrier having, or behaving in a manner associated with a negative Poisson ratio, the method comprising the generation of, or variation of, a tensile and/or compressive load or displacement in one or more directions in the barrier, the load or displacement causing a variation in the effective pore size of the barrier in one or more directions, a wash component being applied to the barrier to remove at least some of the retained component(s) from the barrier.

The third aspect may further include details of the invention and its possibilities set out elsewhere in this application.

According to a fourth aspect of the invention we provide a method for producing barrier materials, the method comprising applying a series of laser pulses to a substrate, the laser pulses ablating material from the substrate, the ablation being provided in a pattern defining a material configuration having a negative Poisson ratio.

Preferably the laser pulses are applied to the substrate by application at a first position followed by movement to a further position prior to application of a further pulse. One or more pulses may be applied to any one location. The pulses may be applied by a plurality of scans across the various positions.

The pulses may be provided at an energy of between 10 and 1000 micro joules, most preferably between 50 and 200 micro joules. The laser pulse may be focused to an area of between 10 and 300 microns in diameter, most preferably between 50 and 125 microns in diameter.

The fluence of the pulses may be provided at between 0.5 and 2 Jcm⁻².

The substrate may be a polymeric material or silicon or any ablatable material.

Preferably pulses of between 50 and 500 femtosecond duration are applied. Preferably the pulses are applied at between 150 and 250 femtoseconds.

Preferably the wavelength of the laser pulse is between 170 and 800 nanometres, most preferably between 350 and 450 nanometres.

### BRIEF DESCRIPTION OF THE DRAWINGS

Various embodiments of the invention and its mode of operation will now be described, by way of example only, and with reference to the accompanying drawings in which:-

FIG. 1a illustrates a negative Poisson ratio material in a relaxed state;

FIG. 1b illustrates the material of FIG. 1a in a stretched state where deformation is due to hinging of the cross beams of the structure;

FIG. 2a illustrates the bending characteristics of a conventional material;

FIG. 2b illustrates the bending characteristics of an auxetic material;

FIG. 3a illustrates a filtration barrier at the start of operation;

FIG. 3b illustrates the barrier of FIG. 3a after the build up of retained solid;

FIG. 4a provides a side sectional view of an adjustable load filter barrier;

FIG. 4b provides a cross-sectional view of the system of FIG. 4a;

FIG. 5 illustrates the use of the invention in a cross flow filtration application;

FIG. 6a illustrates the fouling of a filter according to the present invention;

FIG. 6b illustrates the de-fouling, by backwashing, of the filter of FIG. 6a;

FIG. 7 illustrates the principles involved in adjusting and washing an anisotropic auxetic filter according to the present invention;

FIG. 8 schematically illustrates a test rig used to demonstrate the effectiveness of the present invention;

FIG. 9 illustrates the ratio of the number of blocked pores relative to the initial number of blocked pores as a function of applied uniaxial stress in both principal directions for an auxetic membrane structure;

FIG. 10 illustrates weight throughput against applied strain % for barriers tested according to the test rig of FIG. 8;

FIG. 11 illustrates the mass remaining on or within a barrier to initial mass ratio against longitudinal strain for both a marginally auxetic barrier and an auxetic barrier;

FIG. 12a illustrates pressure drop across an auxetic barrier with varying air flow rates at increasing levels of applied strain;

FIG. 12b illustrates pressure drop across an auxetic barrier with air flow rate for decreasing levels of strain;

FIG. 13 provides a plot of air pressure drop, at a flow rate of 0.75 arbitrary units, against applied strain for a conventional foam of 60 ppi, conventional foam of 30 ppi and an auxetic foam of approximately 45 ppi;

FIG. 14 illustrates the channeled structure of zeolite ZSM5;

FIG. 15 illustrates the calculated variation in loading of benzene and neopentane sorbate molecules in ZSM5 under external stress in the Z direction;

FIG. 16a is an environmental scanning electromicrograph of a conventional open celled polyurethane foam;

FIG. 16b is an environmental scanning electromicrograph of an auxetic foam produced by triaxial compression and heat treatment of conventional foam;

FIG. 17 illustrates a system for ablation production of auxetic materials;

FIG. 18a illustrates a non-auxetic membrane structure produced by laser ablation; and

FIG. 18b illustrates an auxetic membrane structure produced by laser ablation;

### DETAILED DESCRIPTION OF THE PREFERRED EMBODIMENT

Auxetic Material

The Poisson ratio for a material is determined by the ratio of the contractile transverse strain relative to the tensile longitudinal strain.

Conventional materials, when stretched longitudinally tend to become thinner in cross-section. In such cases, the Poisson ratio for the material is positive.

However, a class of materials, known as auxetic materials, exhibit a negative Poisson ratio and become fatter as they are stretched. The manner in which the stretching of the material manifests itself in this way can be based on the geometry and deformation mechanism for the material, either on a molecular micro- or macro-scale. The effect may arise due to the bond structure of the material or due to the physical configuration it possesses. The converse is also true for compression.

FIG. 1a illustrates an auxetic material or structure in a relaxed, non-stressed state. The geometry of the material or structure is formed by a series of parallel bars 2 linked to one another by cross-bars 4a, 4b. The cross bars 4a, 4b are inclined towards an opposing pair of cross-bars 4a, 4b. The cross-bars 4a, 4b are also joined at junction 8 to one another and to the end of one of another set of parallel bars 12. The two dimensional geometric pattern shown extends for many repeats in each direction. If a stretching force is applied with a component along the bars 2, or alternatively with a component perpendicular thereto, then the tessellated re-entrant honeycomb is deformed. The “bow-tie” honeycombs may deform by flexing or hinging of the cross-bars 4a, 4b into line with one another. This movement increases the dimension of the structure both parallel to the bars 2, 12, and perpendicular to the bars 2, 12, as the base of the bars 12 moves away from the bars 2 in both these directions, as the cross-bars 4a, 4b, align.

This increase, multiplied over the significant number of units forming the whole, gives a significant size change. More importantly for many applications it also results in a significant variation in the size of the gap 14 through each honeycomb. The gap is larger in FIG. 1b than FIG. 1a.

The effect is enhanced still further where bi-axial loads are applied.

Biaxial loading of positive Poisson ratio materials or structures merely leads to the deformations tending to cancel one another out.

The nature of auxetic sheet materials and structures also present them with significant advantages where they are required to flex into a dome shape (synclastic curvature). As shown in FIG. 2a a conventional material attempting to curve, due to its positive Poisson ratio, undergoes anticlastic curvature (i.e. it forms a saddle shape). For this reason forcing a Positive Poisson Ratio material or structure into a dome shape often results in localized damage to the material or structure and this overtime limits effective material life. FIG. 2b on the other hand shows the synclastic deformation of auxetic sheet materials or structures from a flat plane in response to out-of-plane movement. Auxetic materials and structures, therefore, have a greater capacity to undergo deformation of this kind without damage.

The potential for increasing the gap dimensions and/or flexing the material have significant benefits when developed and applied correctly to filtration and other separation environments.

Adjusting Filters

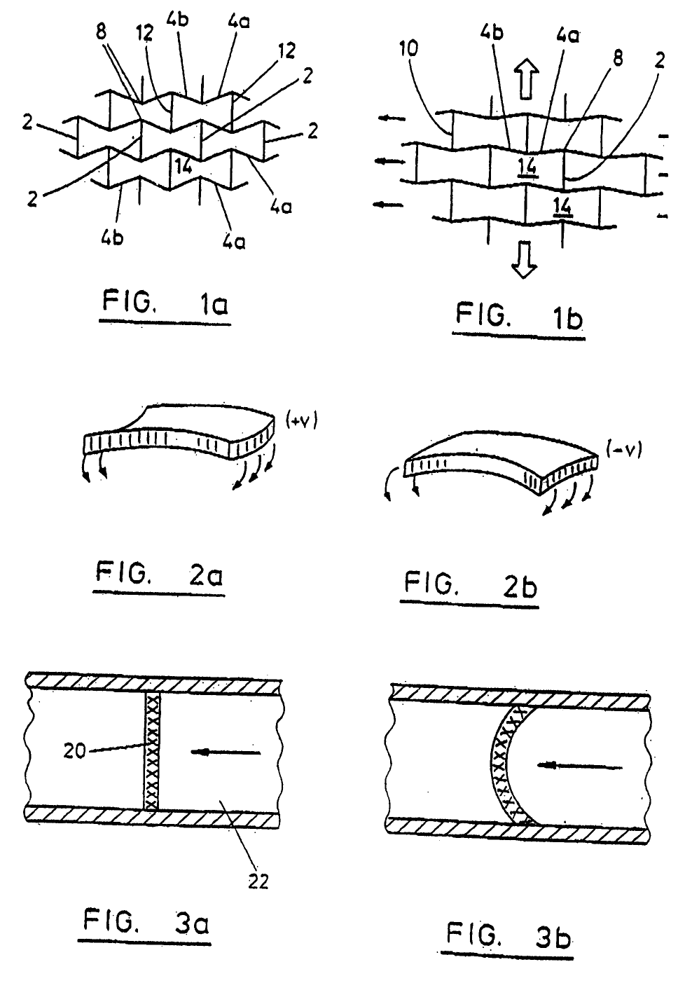

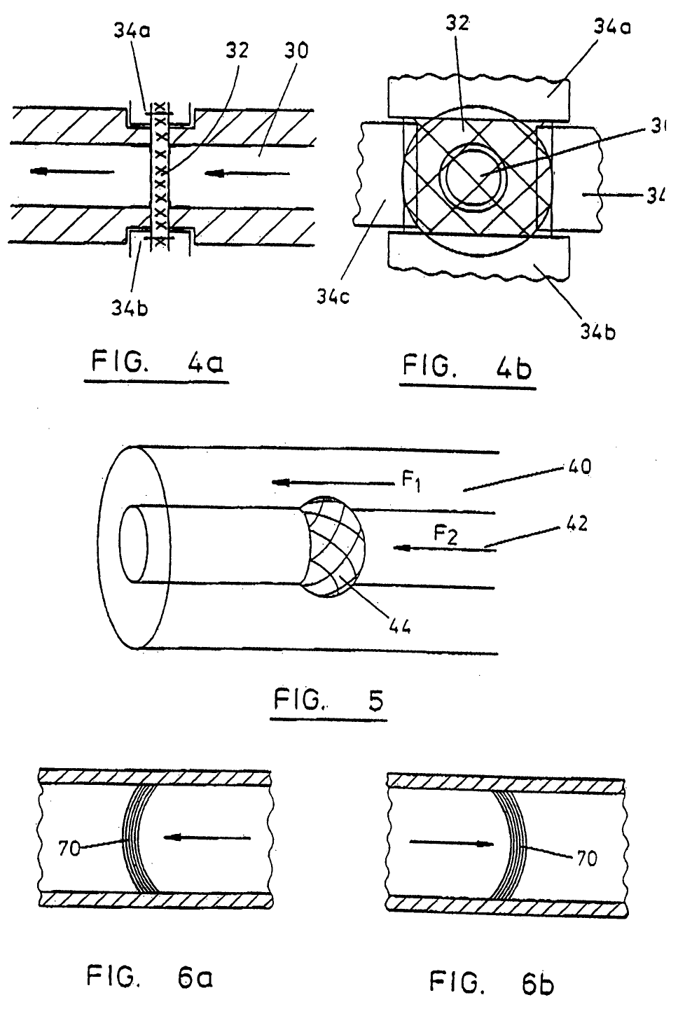

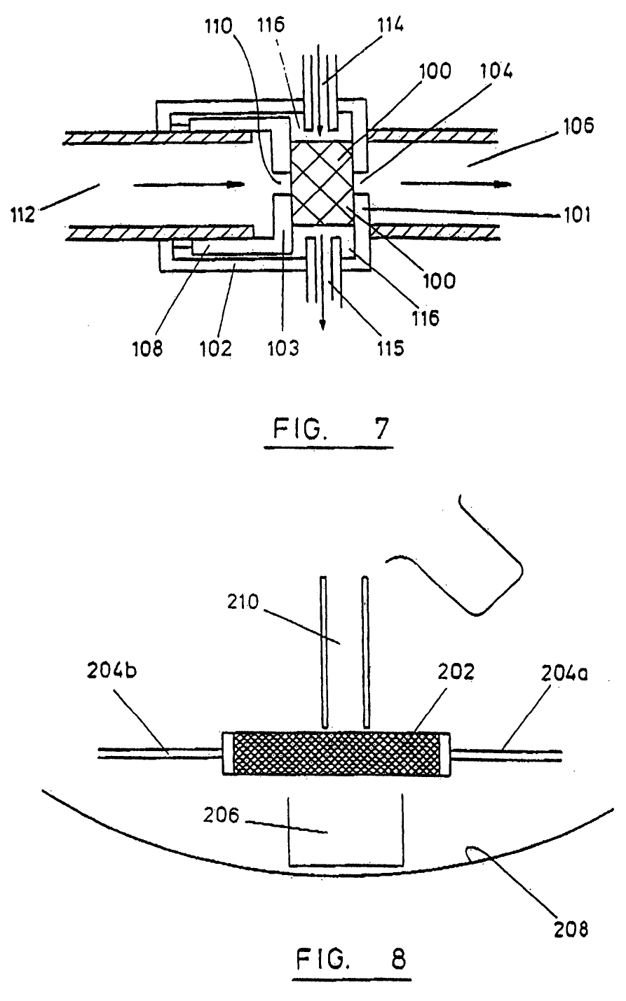

One such application is illustrated in FIG. 3a where a filtration barrier 20 is mounted in a planar manner across a conduit 22 through which a mixture of solids and liquids are passing. As the mixture flows through the conduit 22 the solids are retained on the barrier 20 and gradually build up. A pressure drop naturally exists across the barrier 20 and this applies a force on the barrier 20.

As the solids build up increases so does the pressure drop and the force on the barrier 20, with the net result that it starts to bow with the flow, FIG. 3b.

This bowing is possible, in a fully reversible manner with auxetic materials or structures due to the synclastic bowing discussed above. A conventional material under going such bending would be damaged.

The bowing stretches the barrier 20 and increases the gap size in it. In effect, therefore, self correction for the effect of the fouling of the barrier by the retained solids is provided. As the effective gap size for the barrier is reduced by the solids so the barrier stretches and opens up the pores to compensate. This effect is self-correcting and requires no external control.

Due to the nature of such bowing action such pore variation, may, however, be uneven across the barrier and planar deformation may be preferred as a result.

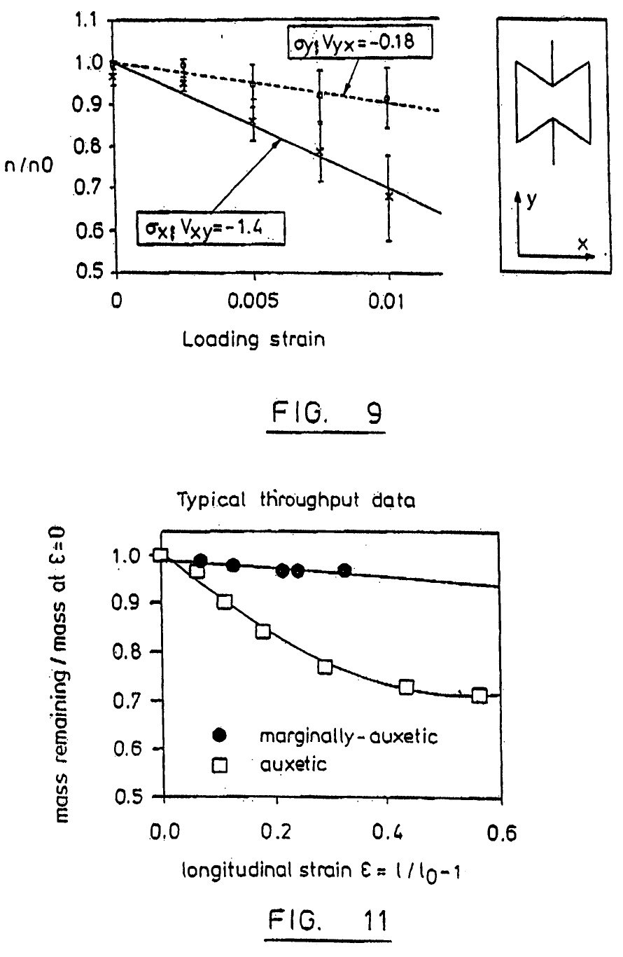

In an alternative form, FIG. 4a and 4b, it is possible to actively control the pore size of the barrier by varying the applied strain. The side view of FIG. 4a provides a conduit 30 through which solids in a liquid suspension flow. A barrier 32 of auxetic material spans the conduit 30 and is mounted in the sides of a frame 34a to 34d which can be moved to vary the applied strain on the barrier 32. Suitable seals are provided between the walls of the conduit 30 and the sides 34a to 34d.

Thus as solids build up and begin to foul the barrier 32 it is possible to apply a stretching load to the pair of sides 34a, 34b and/or to the sides 34c, 34d. In response to the load the auxetic material or structures increases its effective pore size back to that of the initial filtration conditions. Consistent filtration is thus provided.

The load applied to the barrier 32 in this case is externally controlled and so it is desirable to monitor the operating conditions within the system. Detectors for the pressure drop across the barrier 32, flow rate metering and/or filtrate concentration may be determined and used to adjust the load applied, and hence properties of, the barrier 32.

This mode of barrier employment can be used in both cake style filtration where the solids are retained on the surface of the barrier or in depth filtration where the solids enter and are retained within the barrier. In depth filtration the pore size may decrease with depth to increase the effectiveness of filtration.

Barriers or membranes of auxetic material or structure need not be used across the full conduit flow to be effective and obtain benefits. FIG. 5 provides a schematic perspective view of a pair of concentric conduits 40, 42 with a flexible auxetic barrier 44 provided between the two.

When the filter becomes fouled the control of the flow rates in the two conduits can be employed to control the pressure drop across the barrier 44. Increasing the pressure differential between the inner, high pressure conduit 42 and the lower pressure outer conduit 40 causes the barrier to bulge outward. In turn, this bulging of the barrier 44 results in the opening of the pores to counteract the fouling. As in the previous systems, therefore, it is possible to control the effective pore size in the barrier.

The exact control conditions can be varied to account for the filter deformation required, the viscosity and other properties of the two fluids. Where the same fluid is involved in both conduits then the pressure drop can be achieved through a lower flow rate in the outer pipe.

Real time control of the barrier can be effected by monitoring filtrate concentration and/or flowrates, with the outputs forming a feed back control loop to the barrier strain controls.

De-Fouling Filters

As well as being used to maintain the efficiency of filtration operations, the materials of the present invention are also readily de-fouled, unclogged or cleaned.

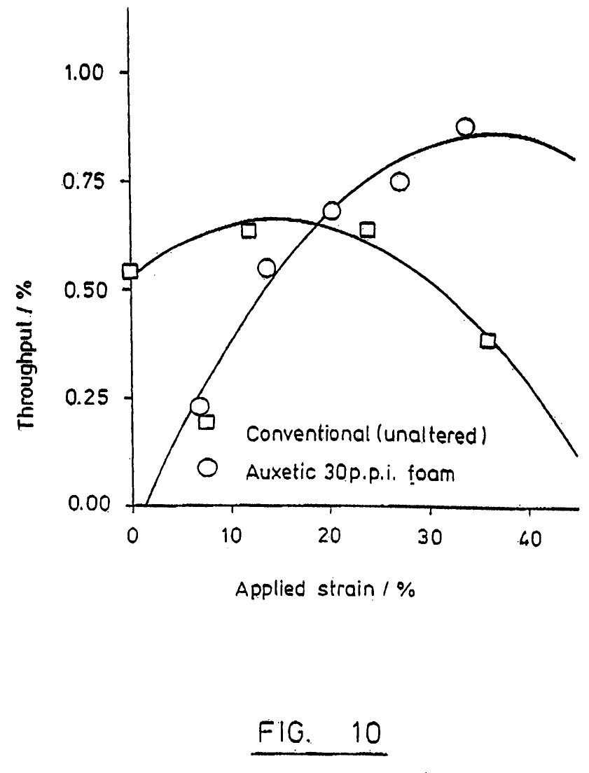

FIG. 6a provides an illustration of a filter barrier 70 which has been operated for some time to restrain solids in a fluid flow. Invariably the barrier has varying efficiency in retaining the solids where the size of those solids decreases towards the effective pore size of the barrier 70. Whilst much of the solids may be retained as a filter cake on the outside of the barrier 70 some of the particles will penetrate the barrier and become retained therein. As previously noted these reduce the efficiency of the filtration process as they build up.

In conventional filtration systems it is the practice to backwash the barrier by occasionally applying a fluid flow in the opposing direction to the filtration flow direction. Such backwashes, however, are only partially successful in removing material as just as the barrier restrains the material during filtration then the pores restrain it during backwashing too. The limited time available for backwashing only removes part of the solids and the performance is not returned to the as new level.

Using the present invention the barrier 70 can be operated at a fixed size or as an adjusting barrier as detailed above. Either way some build up of solids will occur. If the barrier 70 is backwashed at a significant flow rate then the pressure will cause the barrier 70 to undergo synclastic bending, FIG. 6b. Such bending in the present invention results in the pore size being opened up. The reduced restraining action then allows the solids to be readily washed from the barrier to recover its full efficiency.

Such enhanced de-fouling can also be achieved by actively applying a strain to the barrier. By increasing the separation of mounting arms the width of the barrier is increased and the pore size is also increased. Backflushing under such conditions will have increased effect. Back flushing of this type can be applied in a series of cycles to encourage still further the dislodging process.

Bending, reducing the bend or reversing the bend of a barrier can also assist in encouraging the removal of any filter cake which may have adhered to the barrier.

As with the benefits in filtration efficiency, the barrier need not be presented across the full flow of the fluid, the benefits are still obtained in backwashing a system of the type illustrated in FIG. 5.

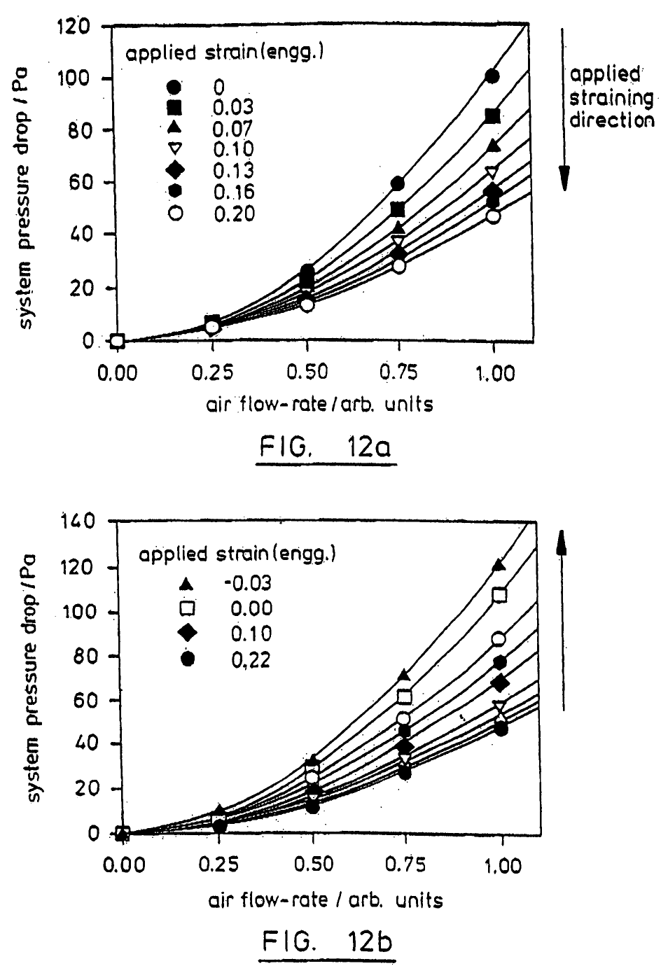

The benefits of auxetic materials and structures can be extended still further where anisotropic materials are used. In the system of FIG. 7 an anisotropic barrier 100 is mounted on an end face 101 of a cylinder 102, across an outlet 104 therefrom which leads into conduit 106. The barrier 100 is mounted on the opposing side on the end face 103 of a piston 108 configured to the cylinder 102. The piston 108 is capable of sliding movement within the cylinder 102. The piston 108 has an aperture 110 therein to allow flow from conduit 112 to the barrier 100 and hence to conduit 106 of the medium to be filtered. Conduit 112 is mounted within the inside of the piston 108.

The cylinder 102 is also provided with two opposing pipes 114, 115 which are linked to the space 116 defined by the cylinder 102, piston 108 and barrier 100.

In operation the medium with suspended solids is passed along conduit 112 and through the barrier 100, with the solids being retained on/in the barrier 100. After a period of time has elapsed build up of solids may become a problem. At that stage the piston 108 is advanced in the cylinder 102 to apply a tensile load to the barrier 100. This load results in the pores of the barrier 100 opening up in one or more directions perpendicular to the filtering flow direction. If a cross-flow wash is now applied to the barrier through pipe 114 then the solids in the barrier 100 are no longer restrained and they can be washed out through pipe 115 so cleaning the barrier 100.

By careful control of the barrier properties the barrier can be arranged such that the loading varies the pore size transverse to the flow direction whilst leaving it unaffected in the flow direction. This means that cross-flow cleaning can be effected during filtration without solids becoming lost to the filtrate outflow through conduit 106.

Once again the process may be assisted by cyclically varying the load and hence transverse pore size.

Experimental Demonstration

To demonstrate the advantages of the present invention's barrier material over existing barrier materials a series of tests aimed at simulating gas-solid separations were conducted.

The test apparatus used is illustrated in FIG. 8 and consists of barrier material 202 positioned between arms 204a, 204b of a tensimeter and over a collection cup 206 and wider diameter collection dish 208. A tube 210 is positioned slightly above the surface of the barrier 202 and is used to control the area of application of the solid particles to be separated.

The tube 210 is 2 cm in diameter and 11 cm long and feeds the glass particle under consideration to the barrier 202. The tube is intended to restrain glass beads which would otherwise attempt to spread laterally over the top surface of the barrier 202. The cup 206 collects those particles which pass relatively directly through the barrier 202 whilst the dish 208 is aimed at collecting any particle spread and so account as far as possible for the fate of particles fed to the barrier 202.

With the barrier 202 in its undeformed state 1.0 g of glass beads, 60 mesh, is applied to the top surface of the barrier 202. Any flow of particles through the barrier 202 to the cup 206 or dish 208 is allowed to proceed to its natural conclusion. With out any agitation of the barrier 202 it is stretch by a first amount and any further throughput to the cup 206 or dish 208 collected. The cup 206 is then set aside for measurement.

The cup 206 is then replaced with another and the process repeated from the glass bead introduction onward, but with a greater extension of the barrier 202.

At the end of four runs the weights of beads collected in the cups 206 are determined as is the weight collected in the dish 208. The glass beads retained in the barrier 202 are removed by agitation and weighed also.

Such tests were conducted by challenging auxetic and non-auxetic membranes with glass beads, where the glass beads were of comparable size to the diameter of a sphere able to pass through a pore in the undeformed membrane in each case. The particle throughput was then observed as a function of applied tensile stress. The results, expressed as the ratio of the number of blocked pores relative to the initial number of blocked pores as a function of applied uniaxial stress is illustrated in FIG. 9. No detectable decrease in blockage was observed for the non-auxetic material. Again, the potential of auxetic materials as a membrane in cleanable filters is illustrated. Furthermore, the rate of de-fouling with applied load is seen to be dependent on the magnitude of the negative Poisson's ratio. The larger the magnitude of the negative Poisson's ratio the greater the rate of de-fouling with applied load (see data for υxv=−1.4 cf υyx=−0.18 in FIG. 9).

As well as 2D based systems, similar experiments were conducted on 3D foam based systems. The production of the auxetic foam based materials is discussed below.

The results in Table 1 are representative of the experimental procedure, repeated for 3 runs in total at different bead sizes, for instance, 80 mesh, 60 mesh and 40 mesh.

TABLE 1

| Barrier - Auxetic foam from 1.33 isotropic compression of 30 ppi | | |
|---|---|---|
| foam, 1.0 cm thick | | |
| Particles - Glass beads, 60 mesh | | |
| Gauge Length | Input | Throughput |
| (+extension) cm | g +/− 0.03 g | g +/− 0.03 g |
| 6.0 (+0.5) | 1.00 | 0.05 |
| 6.5 (+0.5) | 1.00 | 0.12 |
| 7.0 (+0.5) | 1.00 | 0.33 |
| 7.5 (+0.5) | 1.00 | 0.43 |
| TOTAL | 4.00 | 0.93 |
| RETAINED | | 2.59 |
| GENERAL SPILL | | 0.16 |

Similar results are obtainable with protocols based on application of beads to a fresh barrier at the same elongation's or where a single sample of beads is applied and the passage as the elongation is increased is measured.

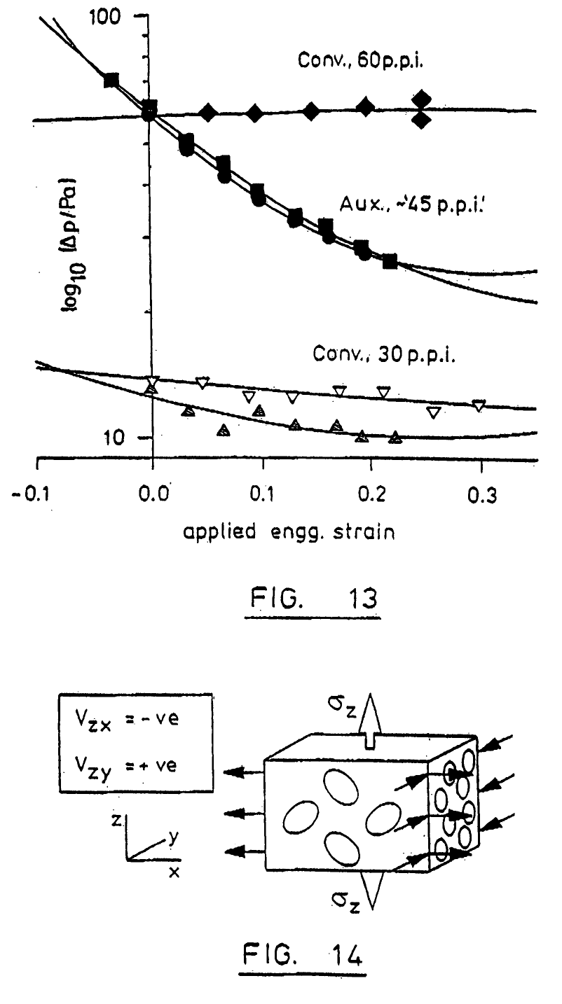

The variation in the extent to which the beads are retained, with the variation in elongation for an example using this analysis is shown in FIG. 10 for a 60 mesh example, both for an auxetic barrier and a conventional foam barrier.

As can clearly be seen the throughput for the conventional foam barrier is unaffected by the applied strain in the early stages. Higher levels of strain reduce the solids passage as the through pores are effectively closed off. Thus for the conventional foam no useful variation in effective pore size occurred and no benefit is derived from strain variation.

With the auxetic material on the other hand the increase in strain leads to a clear increase in the level of material passing through the barrier. This provides a clear indication for such barriers that the strain can be used to control the size of particles passing through the barrier and that a large increase in strain could be used to release entrained material from the barrier, for instance during a backwashing stage.

FIG. 11 illustrates the mass remaining to initial mass ratio for glass beads on or within a foam barrier against longitudinal strain for both an auxetic specimen (υ˜−0.3) and for a marginally-auxetic specimen (−0.1<υ<0.0). These two specimens were compared as fabrication of samples having similar internal geometry, but with differing Poisson ratios, is simpler in such cases than for a fully non-auxetic foam.

Once again, the results demonstrate that an auxetic foam has greater strain-dependent de-fouling properties than a marginal auxetic material. These results demonstrate that benefits due to the auxetic effects persist even where filter thickness and pore tortuosity effects are present.

In these tests, marginally auxetic materials were produced by improper cooling before application of the heat setting process, heat setting too high a temperature or subjected to too long a period of high temperature compression. These materials, however, were very similar in other respects to the auxetic materials with which they were compared.

As well as particle throughput, air pressure drop across foam barriers was also investigated. Investigations using both a hand held air pressure meter and using a universal testing machine to investigate the whole pressure drop from the assembly were conducted.

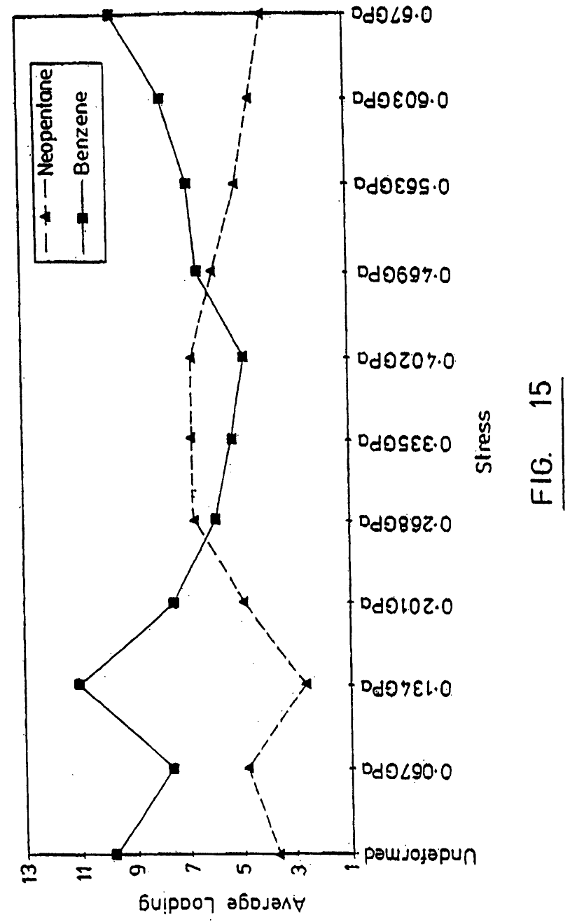

FIG. 12a illustrates air pressure drop against air flow rate with varying levels of applied strain, with the strain increasing. In FIG. 12b the tests were conducted at maximum tensile deformation initially, with the tensile strain being slackened off, through various values, through zero strain to a slight positive compression. Conducting both tests in this way establishes that the results derive from the material behavior rather than any other variable in the system.

As the results clearly show, the auxetic material behavior is consistent with the desired behavior and hence the possibility of correcting for pressure drop variation (due to, for example fouling of the barrier) passively or actively.

Similar tests conducted on non-auxetic material demonstrated increasing pressure drop with air flow rate, but with very little variation in the plot between different applied strain rates.

Comparison of a conventional foam of 60 ppi, a conventional foam of 30 ppi and an auxetic foam of approximately 45 ppi, plotted as pressure drop for a given flow rate against applied strain, are shown in FIG. 13. As can be seen applying the strain has very little affect on the conventional materials but a substantial affect on the auxetic material.

Mathematical Modeling

As well as macro-scale experimental testing mathematical modeling of auxetic materials at a molecular level was also performed. In particular, consideration was given to a number of zeolites.

Zeolites are molecular-level tetrahedral framework structures. The channeled structure of a typical zeolite, ZSM5, is shown schematically in FIG. 14 and consists of a series of channels running along the X axis and a second series of channels running along the Y axis, as defined in the illustration.

Using the CERIUS 2 proprietary molecular modeling software (supplied by Molecular Simulations Inc) ZSM5 was established to possess both negative (υzx) and positive (υzy) Poissons ratios. This conclusion stems from the calculations which indicate that when stretched in the Z direction, single-crystal ZSM will deform by expanding in one of the transverse directions (the X direction) whilst contracting in the other orthogonal transverse direction (the Y direction). The actual values of all the calculated Poisson ratios are υxy=+0.24, υxz=−0.13, υyx=+0.54, υyx=+0.34, υzx=−0.33, υzy=+0.38. The material is thus auxetic in the Z-X plane but non-auxetic in the Z-Y plane. The mechanical properties of ZSM5 calculated using the constant stress minimization method after minimization of the molecular structure using the BKS1.01 forcefield and an RMS value of 0.001 in the minimization. The BKS1.01 forcefield has been developed specifically to describe the properties (including mechanical properties) of zeolites.

A similar analysis on a number of other zeolite types (greater than 70) revealed that approximately 57% of those analyzed using this modeling software were calculated to exhibit auxetic behavior. Investigations using other forcefields than the BKS1.01 forcefield, have also indicated that many zeolites can be expected to be auxetic. Investigation in this way has not previously been conducted on zeolite materials.

Non-deformed structures of ZSM5 are known to allow benzene molecules to diffuse into the structure whereas the slightly larger neopentane molecules are excluded.

Using molecular modeling, the variation of loading of these two sorbate molecules as a function of tensile stress in the Z direction was calculated. The results are presented in FIG. 15. The sorption calculations employed a sorption temperature of 300K and used the sor-yashonath 1.01 sorption forcefield. Simulations were performed using the fixed pressure method which is a grand cononical Monte Carlo method in which the sorbate molecule positions and orientations are varied and sorbates are allowed to be created and destroyed. The sor-yashonath 1.01 sorption forcefield is again the proprietary forcefield designed for sorption of rigid small molecules on to zeolite structures.

Clear differences in the strain dependent diffusion profile for the two species were established for positive and negative Poisson ratios within the Zeolite system under deformation. Molecular level confirmation for the benefits of auxetic behavior is thus shown. Selective separation based on auxetic behavior were thus established.

Production of Auxetic Foam Barriers

Using the techniques of the present invention, described in more detail below, it is possible to produce auxetic foam barriers from conventional foam barriers and achieve a Poisson ratio of −0.2 or below.

The auxetic materials can be produced from conventional foams of the type used in air filtration systems, for instance. Auxetic foam samples were fabricated by compressing a commercial polymer (urethane-co-ester) copolymer foam, manufactured by Reticel under the trade name of BULPREN. The structure of these foams was determined to approximate to tetrakaidecahedra (14-sided polygons) which tessellate so as to fill space. A feature of these foams is that they have a residual anisotropy, the polygons being elongated in one direction, arising from the foaming process in which the evolved gas rises and takes the polymer melt with it. For this reason the long axis of the ellipsoids is termed the rise direction. As a consequence of this anisotropy in the mechanical properties of the foam, when rendered auxetic, is that it is particularly suited to the type of system illustrated in FIG. 7.

This conventional non-auxetic foam can be rendered auxetic by compressing the foam at a temperature of 200° C., (close to its softening point) for a brief period (in the order of 5 minutes) followed by a heat-setting process at 100° C. for 1 hour. The foam was evenly compressed in a cuboid mould during this operation so as to produce a final density of 0.092 g/cm−3 compared with an initial density of 0.039 g/cm−3.

A longer initial heat treatment period (around 30 minutes) was found to remove any auxetic effect from the material.

Carbonization of foams in this way takes the polymer ribs into a mesophase, manifested as a spongy, plastic state, and then on to stiff materials (up to an order of magnitude stiffer than the parent materials). Foams which were auxetic after heat treatment but before carbonization were frequently found to lose their auxetic properties following carbonization.

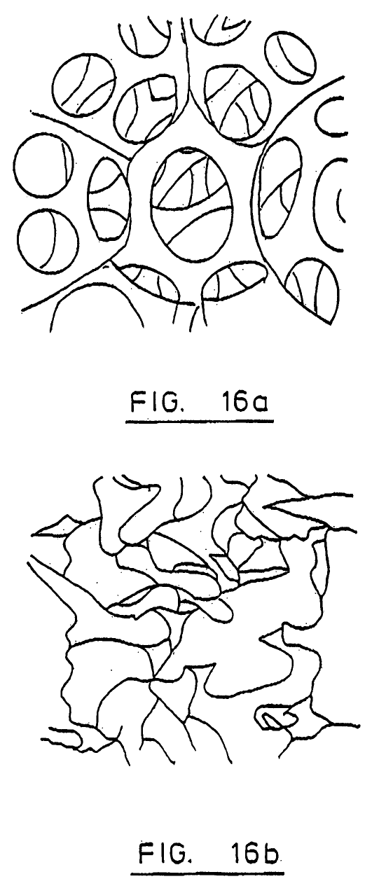

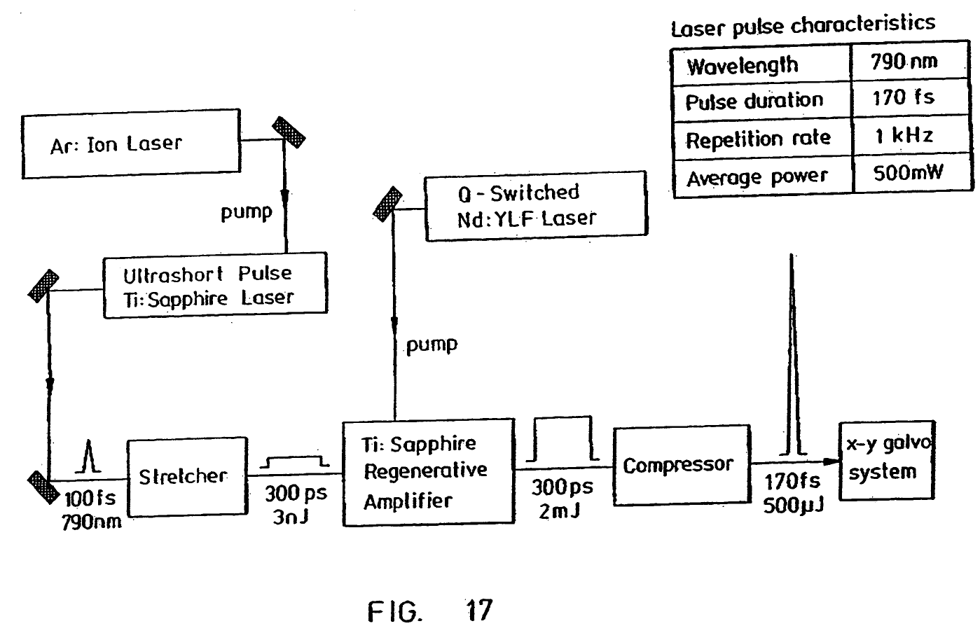

Environmental scanning electromicrographs, demonstrate the non-auxetic structure typical of a conventional open celled polyurethane foam, FIG. 16a and also revealed the converted structure, FIG. 16b, which demonstrates auxetic behavior.

Careful control of the conversion process enables foams of similar internal geometry, but differing values of Poissons ratio, to be obtained.

Production of Micromachined Barriers

Using the techniques of the present invention it is also possible to generate, directly in a one stage process, very fine auxetic materials. The techniques, based on ablation using femtosecond lasers applied to polymeric materials, enables honeycomb auxetic materials of the type described above, and capable of large strain deformation, to be formed at unprecedented fine sizes.

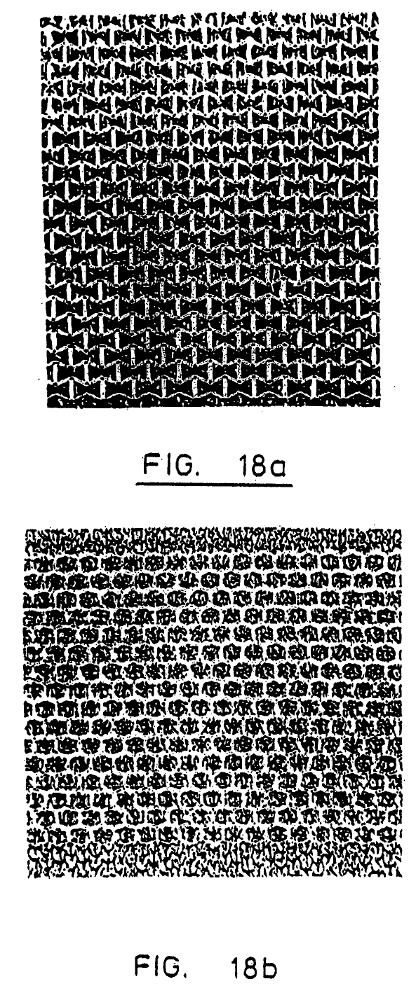

A system suitable for implementing such a process is shown in FIG. 17. The system employed pulses from a 1 kHz titanium sapphire regenerative amplifier at 790 nm which were frequency doubled in a BBO crystal (Type 1 phase matching) to produce a 395 nm near UV pulses of approximately 200 fs duration. The femtosecond laser output was directed via a pair of temperature stabilized galvo-mirrors (General Scanning Inc) onto a plano-convex silica lens (focal length 150 mm) and focused at the substrate surface to approximately 100 um diameter. Pulses of 100 uJ, corresponding to a fluence of 1.3 Jcm⁻², were used to mark the cell circumference at a scan speed of 5 mms−1. The polymer substrate of thickness 128 μm was penetrated after approximately 5 overscans per cell (corresponding to approximately 100 pulses/spot diameter).

Examples of the non-auxetic and auxetic materials produced in this manner are illustrated in FIGS. 18a and 18b respectively. The resulting cell dimensions measured from optical micrographs were H=0.78 (+/−0.03) mm, L=0.54 (+/−0.02) mm, T=0.086 (+/−0.006) mm, α=−23 (+/−5)° for the re-entrant honeycomb membrane and H=0.69 (+/−0.07) mm, L=0.56 (+/−0.02) mm, T=0.14 (+/−0.03) mm, α=+23 (+/−2)° for the conventional honeycomb membrane. H is the length of the vertical ribs (e.g. bars 2 in FIG. 1), L is the length of the diagonal ribs (e.g. cross bars 4a and 4b in FIG. 1), T is the thickness of the ribs and α is the angle of the diagonal ribs with the horizontal axis. The auxetic material can then be employed as desired.

Femtosecond laser ablation of silicon substrates has also been demonstrated using this technique, at fluences of 2 J/cm2, by reducing the focus spot diameter (approx. 50 um diameter at 100 uJ).

The concept of the present invention, both in terms of controlling capture size/efficiency and in terms of facilitating de-fouling of barriers find application in a very wide range of technologies and fields of application. These include, but are not limited to the following examples:

Solid—Gas Separation

Many product or by-product streams in processing plant and other areas consist of solid particles suspended in a gaseous, for instance air, flow. To treat or make use of the solid and/or liquid it is desirable to separate the components and this is frequently achieved by retaining the solids on and/or in a barrier the pores of which are smaller than the particles in question.

Gas—Gas Separation

The present invention can be employed in a variety of manners in separating one or more gas components from one or more other gaseous components.

Molecular sieves based around materials such as zeolites, are used to achieve separation through preferential absorption of molecules in channels provided in the material. The size of the channels controls the size of molecules absorbed and hence provides selectivity for the sieve. The auxetic barriers of the present invention can readily be applied in such a system. The pore size can readily be set, and varied if appropriate, to determine the molecules which are absorbed and those which are not. The possibility of adjusting the pore size also offers advantages in extracting the components after absorption.

The materials of the present invention can also be used to achieve a straight forward separation based on passage of certain size molecules through the barrier and retention of others. To function successfully in this manner the average pore size has to be within an order of magnitude, approximately 5 times, the mean free path of the molecules under consideration, typically 50 um.

Selective Ion Exchange Membranes

Ion exchange membranes take up one or more ionic species from solution to replace species bound to the membrane, these species being displaced into solution as ions. By controlling the pore size on such a membrane the selectivity of the exchange can be increased such that only ions of a certain size are capable of take up, or a preferentially taken up due to their size. The selective nature of the separation makes processing in this way an effective separation procedure.

Reverse Osmosis and Ultrafiltration

Reverse osmosis relies on the application of pressures, greater than the normal osmotic pressure, across a membrane so as to separate a solute from a solvent by causing the solvent to flow through the membrane. The process is typified by seawater desalination, but is applicable to a range of chemical recycling and treatment techniques, as well as food processing.

The barriers of the present invention are capable of production with pores suitably sized for the techniques application and with the advantages of pore adjustability, during and after material passage, as desired. The passage of the solvent and retention of dissolved ions is thus possible.

Separation of ions from solution using porous membranes also finds application in gel permeation chromatography, exclusion chromatography, gel filtration chromatography and other similar techniques.

Ultrafiltration relies again on a suitably sized barrier the pores of which allow the solute, molecular and ionic substances to pass through, but which retain colloidal materials. The process is reliant on the electrical conditions of both the membrane and colloid as well as on a sieving effect.

Production and application of barriers according to the present invention are possible in such applications.

Electrode Membranes and Refining Processes

A number of industrial processes, including electro-refining and a variety of other techniques employ membranes between stages or parts of the same stage to discriminate in terms of one or more components whilst allowing the passage there between of other components.

Solid—Solid Screening

The separation of solids of one size range from other sizes of material is encountered in a variety of processing applications. Such separations may be performed dry or wet and may involve a series of separation stages to give a series of size ranges.

Solid—Liquid Separation

A wide variety of solid/liquid separations can be made based on a barrier system with the solids in general being retained whilst the liquid is allowed to pass. Pressure, gravity, electrokinetic and other driving forces can be used to promote the passage of the fluid. The systems can be operated in through passage mode or alternatives, such as cross-flow filtration. The systems can be applied to a wide range of sizes to treat particles from the macro to micron scale. The techniques are applicable, for instance, to process emulsions, colloids suspensions and other fine mixtures of solids and liquids.

Once again auxetic materials or structures offer significant advantages in adjustability of pore size, fouling accommodation and cleaning of the barriers.

As can be seen from the variety of applications described the present invention offers benefits in a very wide range of technology areas and on a very wide scales, from molecular to microscopic to macroscopic selectivities.

What is claimed is:

1. A method of separating at least part of one or more components from a mixture of components, the method comprising:
exposing the mixture to a porous barrier, the porous barrier having pores with an effective pore size that restrains the passage of at least one or more of the components through the porous barrier, the porous barrier being formed of a material or structure having, or behaving in the manner associated with, a negative Poisson ratio; and
subsequently applying a tensile or compressive load in one or more directions to the porous barrier so as to vary the effective pore size of the pores of the porous barrier.

2. The method according to claim 1 in which the load is applied substantially perpendicular to a direction of flow of one or more components through the porous barrier.

3. The method according to claim 1 in which the load is applied a substantially parallel to a direction of flow of one or more components through the porous barrier.

4. The method according to claim 1 in which the load results in deformation of the porous barrier, the deformation comprising stretching of one or more portions of the porous barrier.

5. The method according to claim 1 in which the load results in deformation of the porous barrier, the deformation comprising compression of one or more portions of the porous barrier.

6. The method according to claim 1 in which the effective pore size of the porous barrier is varied to remove one or more component retained on and/or in the porous barrier.

7. The method according to claim 1 in which the method includes a first stage during which the effective pore size of the porous barrier is not varied, this stage being followed by a stage for removing one or more components retained on and/or in the porous barrier, the further stage comprising the application of a tensile or compressive load in one or more directions in the porous barrier, the load causing a variation in the effective pore size of the porous barrier in one or more directions, such that the retained components can be encouraged to separate from the porous barrier surface and/or exit the porous barrier.

8. The method according to claim 7 in which a flow of liquid or gas is applied to the porous barrier during the further stage or a portion thereof.

9. The method according to claim 7 in which the further stage includes a back washing stage.

10. The method according to claim 8 in which the further stage includes a cross-flow flushing stage.

11. The method according to claim 1 in which a flow containing a mixture of components is introduced through a conduit to one side of the porous barrier, at least part of one or more components of the mixture passing through the porous barrier and flowing through a second conduit, on the opposing side of the porous barrier, away from the porous barrier, the method further comprising, at least some of the time, in applying a flow of material across the porous barrier relative to the first flow.

12. The method according to claim 11 in which the cross flow is accompanied by a variation in the effective pore diameter of the porous barrier, perpendicular to that flow direction only.

13. The method according to claim 1 in which the effective pore size is varied by bowing the porous barrier in an opposing direction to the flow of material into or through the porous barrier during the separation.

14. Separation apparatus, the apparatus comprising:
an inlet for receiving a mixture of components;
a porous barrier through which at least a portion of the mixture of components is passed, the porous barrier having pores with an effective pore size configured to restrain the passage of one or more components of the mixture, the porous barrier being formed of a material or structure exhibiting the behavior exemplified by a negative Poisson ratio;
an outlet for discharging the portion of the mixture that passes through the porous barrier; and
means for applying a tensile or compressive load in one or more directions to the porous barrier so as to enable selective and repeated varying of the effective pore size of the pores of the porous barrier.

15. Apparatus according to claim 14 in which the means for selectively applying a tensile or compressive load comprises one or more elements opposing one another, the separation of which is increased to generate a tensile load.

16. A method of separating at least part of one or more components from a mixture of components, the method comprising:
passing the mixture through a porous barrier so that at least one or more of the components of the mixture is retained on or in the porous barrier, the porous barrier being formed of a material or structure having, or behaving in the manner associated with, a negative Poisson ratio; and
subsequently applying a tensile or compressive load in one or more directions to the porous barrier, the tensile or compressive load being varied during at least a portion of the separation so as to vary the effective pore size of the barrier.

17. The method as recited in claim 16, further comprising applying an external tensile or compressive load in one or more directions to the porous barrier.

18. The method as recited in claim 16, wherein the load is applied substantially perpendicular to a direction of flow of one or more components through the porous barrier.

19. The method as recited in claim 16, wherein the load is applied substantially parallel to a direction of flow of one or more components through the porous barrier.

20. The method as recited in claim 16, further comprising passing a backwash through the barrier in the direction opposite the flow of the mixture of components.
